(19) United States
(12) Patent Application Publication
(10) Pub. No.: US 2012/0253864 A1
(43) Pub. Date: Oct. 4, 2012

(54) METHODS FOR RECORDING AND TRACKING PROJECTS AND DEVICES THEREOF

(75) Inventors: Amulya Anil PARIKH, Dahod (IN); Snehal Ashok REGE, Maharashtra (IN)

(73) Assignee: INFOSYS TECHNOLOGIES, LTD., Bangalore (IN)

(21) Appl. No.: 13/220,247

(22) Filed: Aug. 29, 2011

(30) Foreign Application Priority Data
Mar. 31, 2011 (IN) 1066/CHE/2011

(51) Int. Cl. G06Q 10/06

(52) U.S. Cl. 705/7.12

(57) ABSTRACT

A method, non-transitory computer readable medium and apparatus that obtains project data in one or more form fields of one or more remotely located user based interfaces for a project. The obtained project data from the one or more form fields of the one or more remotely located user based interfaces for the project is validated. The validated project data is recorded in a project database for the project directly from each of the one or more remotely located user based interfaces. A project tracking report is generated based on the recorded project data.

This application claims the benefit of Indian Patent Application Filing No. 1066/CHE/2011, filed Mar. 31, 2011, which is hereby incorporated by reference in its entirety.

### FIELD

This technology relates to methods for recording and tracking projects through one or more stages, such as building construction and development projects, and devices thereof.

### BACKGROUND

One of the challenges with overseeing a project, such as a building construction and development project, is with securing and managing all of the resources needed to bring about the completion of one or more stages of the project. Another challenge with overseeing a project is to optimize the allocation of these resources to complete the one or more stages of the project.

Unfortunately, there currently is no automated mechanism to effectively manage project data to meet these challenges. Most efforts to record and track projects involve manual input of data which is time consuming and prone to human error. Additionally, this project data often is not entered systematically so project management tracking reports are generated based on out of date project data. As a result, with existing technology project management decisions are less efficient in completing stages of a project and the utilization of available resources is not always optimized. Further, since the manually entered project data typically is not entered in a manner which integrates it with other project management tools and systems, this absence of integration results in additional inefficiencies in completing stages of the project.

### SUMMARY

A method for recording and tracking a project including obtaining with a project management computing apparatus project data in one or more form fields of one or more remotely located user based interfaces for a project. The obtained project data from the one or more form fields of the one or more remotely located user based interfaces for the project is validated with the project management computing apparatus. The validated project data is recorded in a project database for the project with the project management computing apparatus directly from each of the one or more remotely located user based interfaces. A project tracking report is generated with the project management computing apparatus based on the recorded project data.

A non-transitory computer readable medium having stored thereon instructions for recording and tracking a project through one or more stages comprising machine executable code which when executed by at least one processor, causes the processor to perform steps including obtaining project data in one or more form fields of one or more remotely located user based interfaces for a project. The obtained project data from the one or more form fields of the one or more remotely located user based interfaces for the project is validated. The validated project data is recorded in a project database for the project directly from each of the one or more remotely located user based interfaces. A project tracking report is generated based on the recorded project data.

A project management computing apparatus includes one or more processors and a memory coupled to the one or more processors which are configured to execute programmed instructions stored in the memory including obtaining project data in one or more form fields of one or more remotely located user based interfaces for a project. The obtained project data from the one or more form fields of the one or more remotely located user based interfaces for the project is validated. The validated project data is recorded in a project database for the project directly from each of the one or more remotely located user based interfaces. A project tracking report is generated based on the recorded project data.

This technology provides a number of advantages including providing more effective methods and devices for recording and tracking projects through one or more stages, such as a building construction and development project. With this technology, multiple remotely located user based interfaces are used to directly provide project data to a database for validation, recordation and tracking by a project management computing apparatus. The remotely located user based interfaces will always remain the same size because project data is not stored at the client computing devices. Additionally, the user based interfaces can optionally be save at the client computing device to further increase processing speed at the project management computing apparatus. Accordingly, this technology helps to more effectively and efficiently manage projects through the different stages or phases with this remote collection and automated integration of project data for validation and recordation from multiple users into a centralized database in a systemized manner.

### BRIEF DESCRIPTION OF THE DRAWINGS

FIG. 1 is an environment with an exemplary project management computing apparatus;

FIG. 2 is a flow chart of an exemplary method for recording and tracking a project through one or more stages; and

FIG. 3 is a flow chart of an exemplary method for creating a new project for recording and tracking.

### DETAILED DESCRIPTION

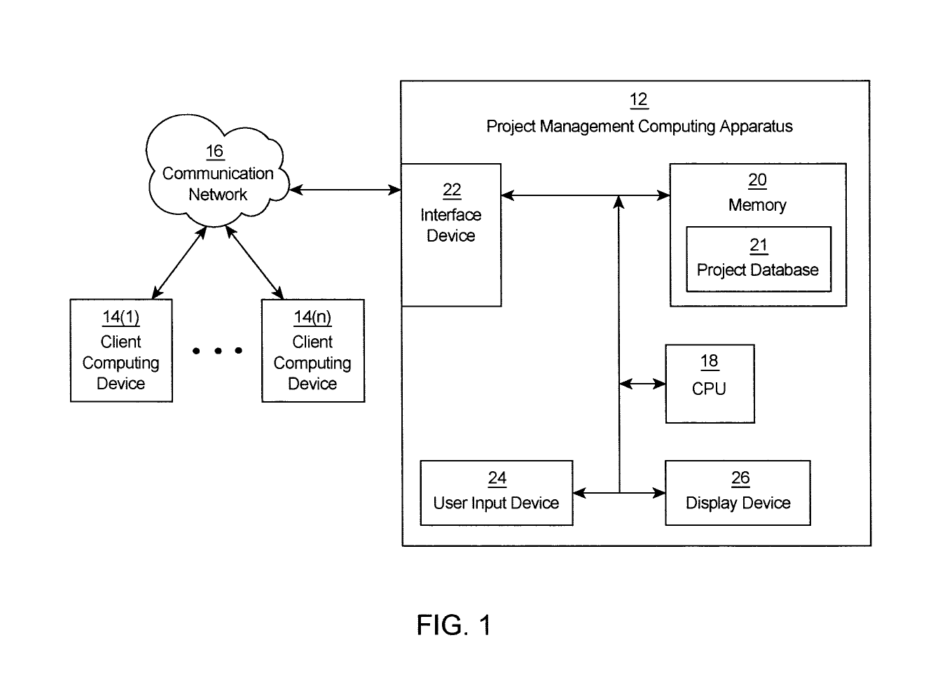

An environment 10 with an exemplary project management computing apparatus 12 is illustrated in FIG. 1. The environment 10 includes the project management computing apparatus 12 and a plurality of client computing devices 14(1)-14(n) which are all coupled together by one or more communication networks 16, although this environment can include other numbers and types of systems, devices, components, and elements in other configurations. This technology provides a number of advantages including providing more effective methods and devices for recording and tracking projects through one or more stages, such as a building construction and development project.

In this example, the project management computing apparatus 12 provides user based interfaces for remote use, directly obtains, validates, formats, and records project data from the remotely located user based interfaces and generates project tracking reports on stages of a project, although other numbers and types of functions could be performed. The project management computing apparatus 12 includes a central processing unit (CPU) or processor 18, a memory 20 with a project database 21, an interface device 22, a user input device 24, and a display device 26 which are coupled together by a bus or other link, although other numbers and types of systems, devices, components, and elements in other configurations and locations can be used. The processor 18 in the project management computing apparatus 12 executes a program of stored instructions for one or more aspects of the present technology as described and illustrated by way of the examples herein, although other types and numbers of processing devices and logic could be used and the processor could execute other numbers and types of programmed instructions.

The memory 20 in the project management computing apparatus 12 stores these programmed instructions for one or more aspects of the present technology as described and illustrated herein, although some or all of the programmed instructions could be stored and executed elsewhere. In this example, the memory 20 includes the project database 21 which is an Access database for projects, although other types of databases which are stored at other locations could be used. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18 in the project management computing apparatus 12, can be used for the memory 20 in the project management computing apparatus 12.

The interface device 22 in the project management computing apparatus 12 is used to operatively couple and communicate between the project management computing apparatus 12 and the client computing devices 14(1)-14(n) via one or more of the communications networks 16, although other types and numbers of communication networks or systems with other types and numbers of connections and configurations can be used. By way of example only, the one or more communications networks can use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

The user input device 24 in the project management computing apparatus 12 includes a computer keyboard and a computer mouse, although other types and numbers of user input devices can be used. In this example, the user input device 24 in the project management computing apparatus 12 is used to input data to register new customers and to input data for one or more fields for creating a project, such as a project name and project status, although other types of data and information could be entered in other manners.

The display device 26 in the project management computing apparatus 12 include a computer display screen, such as a CRT or LCD screen, although other types and numbers of displays could be used. In this example, the display device 26 in the project management computing apparatus 12 is used to display requests to register a new customer and fields which require completion to establish a new project in the project database 21, although other types of data and information and other types of graphical user interfaces could be displayed.

Each of the client computing devices 14(1)-14(n) includes a central processing unit (CPU) or processor, a memory, an interface device, a user input device, and a display which are coupled together by a bus or other link, although each could comprise other numbers and types of devices, elements, and components in other configurations. In this example, each of the client computing devices 14(1)-14(n) is remotely located from the project management computing apparatus 12, although other configurations could be used. The processor in the each of the client computing devices 14(1)-14(n) can execute a program of stored instructions for one or more aspects of the present technology as described and illustrated by way of the examples herein, although other types and numbers of processing devices and logic could be used and the processor could execute other numbers and types of programmed instructions. The display of each of the client computing devices 14(1)-14(n) is used to display the Excel user based interface with one or more form fields. The user input device of each of the client computing devices 14(1)-14(n) is used to input the project data in the form fields of the user based interfaces which are configured to directly provide the project data to the project management computing apparatus 12 for validation, recordation and reporting, although other types and numbers of functions could be performed. Although multiple client computing devices 14(1)-14(n) are shown, other numbers of client computing devices, such as one, and other types and numbers of systems and devices which can display and provide interaction with the user based interface can be used.

Although examples of the project management computing apparatus 12 and the client computing devices 14(1)-14(n) are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. Accordingly, principles and advantages of distributed processing, such as redundancy and replication also can be implemented, as desired, to increase the robustness and performance of the devices and systems of the examples. The examples may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples may also be embodied as a computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

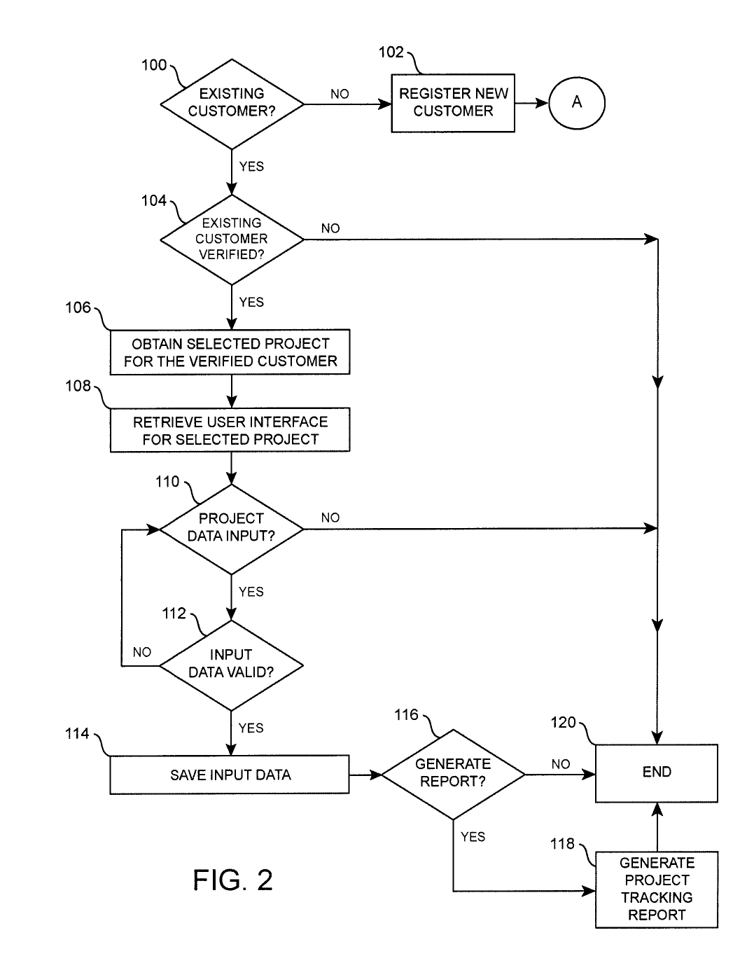

An exemplary method for recording and tracking a project through one or more stages will now be described with reference to FIGS. 1-3. Referring more specifically to FIG. 2, an exemplary method for recording and tracking a project through one or more stages is illustrated.

In step 100 the project management computing apparatus 12 determines whether the requesting one of the client computing devices 14(1)-14(n) is an existing customer for recording and tracking projects. If in step 100, the project management computing apparatus 12 determines the requesting one of the client computing devices 14(1)-14(n) is not an existing customer for recording and tracking projects, then the No branch is taken to step 102.

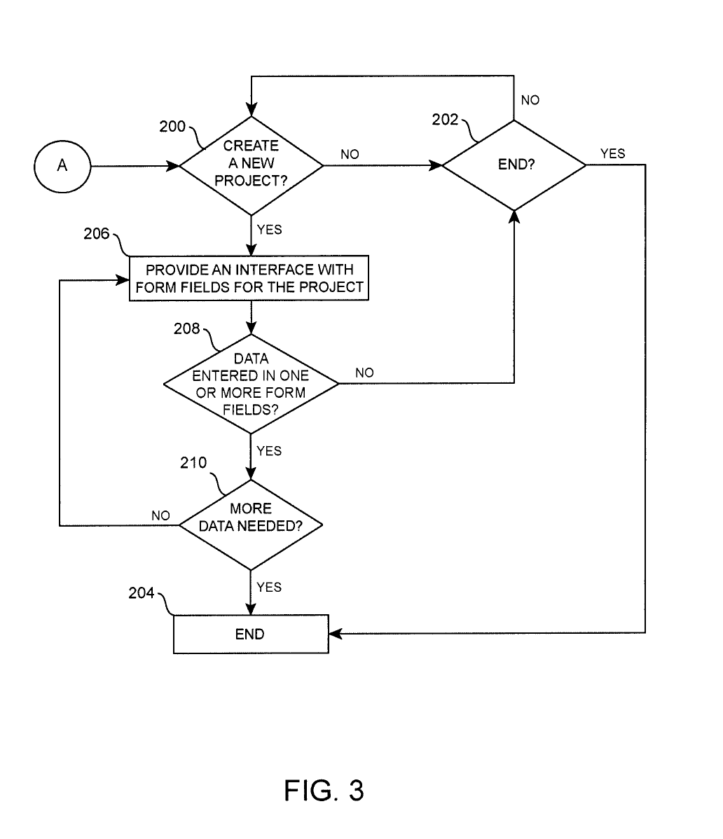

In step 102, the project management computing apparatus 12 obtains information from the requesting one of the client computing devices 14(1)-14(n) to register a new customer and then proceeds to A in FIG. 3.

Referring to FIG. 3, an exemplary method for creating a new project for recording and tracking after registering a new customer or for an existing customer is illustrated. In step 200, the project management computing apparatus 12 determines whether the requesting one of the client computing devices 14(1)-14(n) would like to create a new project for recording and tracking in the project database 21 in the project management computing apparatus 12. If in step 200 the project management computing apparatus 12 determines the requesting one of the client computing devices 14(1)-14(n) would not like to create a new project, then the No branch is taken to step 202.

In step 202, the project management computing apparatus 12 determines whether the requesting one of the client computing devices 14(1)-14(n) would like to end this process. If in step 202, the project management computing apparatus 12 determines the requesting one of the client computing devices 14(1)-14(n) would like to end this process, then the Yes branch is take to step 204 where this method ends. If in step 202, the project management computing apparatus 12 determines the requesting one of the client computing devices 14(1)-14(n) would not like to end this process, then the No branch is take to step 200.

If in step 200 the project management computing apparatus 12 determines the requesting one of the client computing devices 14(1)-14(n) would not like to create a new project, then the No branch is taken to step 206. In step 206, the project management computing apparatus 12 provides an interface with one or more fields to the requesting one of the client computing devices 14(1)-14(n) to complete to create a new project.

In step 208, the project management computing apparatus 12 determines whether the requesting one of the client computing devices 14(1)-14(n) has entered any data for a new project in any of the fields of the interface. If in step 208, the project management computing apparatus 12 determines the requesting one of the client computing devices 14(1)-14(n) has not entered any data, then the No branch is taken to step 202 as described earlier. If in step 208, the project management computing apparatus 12 determines the requesting one of the client computing devices 14(1)-14(n) has entered in one or more of the fields, then the Yes branch is taken to step 210.

In step 210, the project management computing apparatus 12 determines whether more data is needed from the requesting one of the client computing devices 14(1)-14(n) to create a new project in the project database 21 in the project management computing apparatus 12. In this example, the project management computing apparatus 12 needs at least data for the project name and the project status, although other types and minimum amounts of data might be needed to create a new project. If in step 210, the project management computing apparatus 12 determines more data is needed from the requesting one of the client computing devices 14(1)-14(n) to create a new project, then the Yes branch is taken back to step 206 as described earlier with a modified interface to request at least the minimum necessary data to create a new project. If in step 210, the project management computing apparatus 12 determines more data is not needed from the requesting one of the client computing devices 14(1)-14(n) to create a new project, then the No branch is taken back to step 204 where this method for creating a new project ends.

Referring back to FIG. 2, if in step 100 the project management computing apparatus 12 determines the requesting one of the client computing devices 14(1)-14(n) is an existing customer for recording and tracking projects, then the Yes branch is taken to step 104.

In step 104, the project management computing apparatus 12 determines whether the requesting one of the client computing devices 14(1)-14(n) which is an existing customer is verified. If in step 104, the project management computing apparatus 12 determines the requesting one of the client computing devices 14(1)-14(n) is not verified, then the No branch is taken to step 120 where this method ends. If in step 104, the project management computing apparatus 12 determines the requesting one of the client computing devices 14(1)-14(n) is verified, then the Yes branch is taken to step 106.

In step 106, the project management computing apparatus 12 obtains one or more projects from the project database 21 which have been created for the requesting one of the client computing devices 14(1)-14(n). If the requesting one of the client computing devices 14(1)-14(n) has more than one created project, then the project management computing apparatus 12 obtains a selection of one of the stored projects from the requesting one of the client computing devices 14(1)-14(n).

In step 108, the project management computing apparatus 12 obtains from memory 20 an Excel based user interface for the selected project, although other types of user based interfaces and manners for obtaining the user based interface can be used, such as storing the user based interface locally at the requesting one of the client computing devices 14(1)-14(n) which would increase processing speeds at the project management computing apparatus 12. The project management computing apparatus 12 provides the Excel based user interface to the requesting one of the client computing devices 14(1)-14(n) which is shown on the display device at the requesting one of the client computing devices 14(1)-14(n).

In step 110, the project management computing apparatus 12 determines whether the requesting one of the client computing devices 14(1)-14(n) has provided any project data in one or more of the form fields in the user based interface on display device. If in step 110, the project management computing apparatus 12 determines the requesting one of the client computing devices 14(1)-14(n) has not provided any project data, then the No branch is taken to step 120 where this method ends. If in step 110, the project management computing apparatus 12 determines the requesting one of the client computing devices 14(1)-14(n) has provided project data, then the yes branch is taken to step 112.

In step 112, the project management computing apparatus 12 validates and formats the project data provided by the requesting one of the client computing devices 14(1)-14(n) is validated. By way of example only, the project management computing apparatus 12 formats the project name by trimming the project name to remove all extra spaces and converting the project name into UPPER CASE letters, although other types of formatting can be executed and other types of project data can be formatted. Consistent naming of the project by the project management computing apparatus 12 assists in validation.

By way of example only, validation of project data by the project management computing apparatus 12 comprises checking to determine if all necessary information is provided, although other types of validation could be performed. In this example, before pushing project data entered in one or more form fields of one or more remotely located user based interfaces into the access database 21, the project management computing apparatus 12 first checks to ensure that the provided project data is not incomplete with respect to the particular request. In this example, a macro code is executed by the project management computing apparatus 12 that checks field by field to find blank (incomplete/no input) form fields or cells, although other numbers and types of fields could be checked depending on whether a response is necessary for every field for that project. If the project management computing apparatus 12 finds a blank form field or cell for which project data is needed, the project management computing apparatus 12 generates and provides a notice to the one of the client computing devices 14(1)-14(n) interacting with the user based interface that the project data provided is incomplete and it can not be processed further. At the same time, the macro executed by the project management computing apparatus 12 smartly identified and provides the one of the client computing devices 14(1)-14(n) interacting with the user based interface with information as to which field is blank or incomplete and needs to be complete before pushing the data into the access database 21.

In another example of validation, before pushing a new project into the access database 21, the project management computing apparatus 12 checks to make sure that the project does not already exist in the access database 21, although again other types of validations could be performed. This exemplary validation is used to avoid a crash of the access database 21 resulting from referencing inconsistencies if there are multiple projects with the same project name. In this example, the macro code executed by the project management computing apparatus 12 looks for the new project name in a list of existing project names stored in the access database 21. If the project management computing apparatus 12 finds a match, the project management computing apparatus 12 generates and provides the one of the client computing devices 14(1)-14(n) interacting with the user based interface a notice that the project already exists.

Additionally, the project management computing apparatus 12 pulls all existing data for the matched project from the access database 21 and provides it to the one of the client computing devices 14(1)-14(n) interacting with the user based interface for a status update with respect to the currently stored information. This functionality was added because of the versatility of this technology which allows multiple stake holders, such as project managers as well as project customers, to interact with the project data and potentially trying to create a new project without the knowledge that the project is already been created or trying to add a customer without the knowledge that this customer is already in the database. Thus, this exemplary validation helps to reduce duplication of data in the access database, avoids referencing inconsistencies and ensures smooth overall dataflow with respect to the project being managed.

In step 114, the project management computing apparatus 12 stores the formatted and validated project data provided by the requesting one of the client computing devices 14(1)-14(n) in the project database 21, although the data could be stored in other manners and locations. In this example, the size of the user based interface at the requesting one of the client computing devices 14(1)-14(n) always remains the same size because the data is not stored locally. Instead, the Excel based user interfaces are configured to directly provide the project data to the Access database 21 in the project management computing apparatus 12.

In step 116, the project management computing apparatus 12 determines whether the requesting one of the client computing devices 14(1)-14(n) has requested the generation of a tracking report for the project based on the validated and formatted data. If in step 116, the project management computing apparatus 12 determines the requesting one of the client computing devices 14(1)-14(n) has not requested the generation of a tracking report, then the No branch is taken to step 120 where this method ends.

If in step 116, the project management computing apparatus 12 determines the requesting one of the client computing devices 14(1)-14(n) has requested the generation of a tracking report, then the Yes branch is taken to step 118. In step 118, the project management computing apparatus 12 generates and provides on the display device of the requesting one of the client computing devices 14(1)-14(n) the tracking report based on the validated and formatted data for the project and then the method ends in step 120.

Accordingly, as illustrated and described herein this technology provides more effective methods and devices that record and track projects through one or more stages, such as building construction and development projects. With this technology, multiple remotely located user based interfaces are used to directly provide project data to a database for validation, recordation and tracking by a project management computing apparatus. The remotely located user based interfaces will always remain the same size because project data is not stored at the client computing devices. Additionally, the user based interfaces can optionally be save at the client computing device to further increase processing speed at the project management computing apparatus. Accordingly, this technology helps to more effectively and efficiently manage projects through the different stages or phases with this remote collection and automated integration of project data for validation and recordation from multiple users into a centralized database in a systemized manner.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for recording and tracking a project, the method comprising:
obtaining with a project management computing apparatus project data in one or more form fields of one or more remotely located user based interfaces for a project;
validating with the project management computing apparatus the obtained project data from the one or more form fields of the one or more remotely located user based interfaces for the project;
recording with the project management computing apparatus the validated project data in a project database for the project directly from each of the one or more remotely located user based interfaces; and
generating with the project management computing apparatus a project tracking report based on the recorded project data.

2. The method as set forth in claim 1 further comprising providing with the project management computing apparatus the one or more user based interfaces to one or more client computing devices remotely located from the project management computing apparatus.

3. The method as set forth in claim 2 further comprising generating with the project management computing apparatus the project with a plurality of fields for tracking one or more stages in the project database, wherein the one or more form fields of the provided one or more remotely located user based interfaces corresponds with the plurality of fields.

4. The method as set forth in claim 1 wherein the obtaining further comprises obtaining with the project management computing apparatus the project data in the one or more form fields of two or more of the remotely located user based interfaces for the project.

5. The method as set forth in claim 1 wherein at least one of the one or more remotely located user based interfaces is an Excel based user interface and the project database is an Access database.

6. The method as set forth in claim 1 wherein the validating further comprises formatting with the project management computing apparatus the obtained project data from the one or more form fields of the one or more remotely located user based interfaces for the project.

7. A non-transitory computer readable medium having stored thereon instructions for recording and tracking a project through one or more stages comprising machine executable code which when executed by at least one processor, causes the processor to perform steps comprising:
obtaining project data in one or more form fields of one or more remotely located user based interfaces for a project;
validating the obtained project data from the one or more form fields of the one or more remotely located user based interfaces for the project;
recording the validated project data in a project database for the project directly from each of the one or more remotely located user based interfaces; and
generating a project tracking report based on the recorded project data.

8. The medium as set forth in claim 7 further comprising providing the one or more user based interfaces to one or more remotely located client computing devices.

9. The medium as set forth in claim 8 further comprising generating the project with a plurality of fields for tracking one or more stages in the project database, wherein the one or more form fields of the provided one or more remotely located user based interfaces corresponds with the plurality of fields.

10. The medium as set forth in claim 7 wherein the obtaining further comprises obtaining the project data in the one or more form fields of two or more of the remotely located user based interfaces for the project.

11. The medium as set forth in claim 7 wherein at least one of the one or more remotely located user based interfaces is an Excel based user interface and the project database is an Access database.

12. The medium as set forth in claim 7 wherein the validating further comprises formatting the obtained project data from the one or more form fields of the one or more remotely located user based interfaces for the project.

13. A project management computing apparatus comprising:
one or more processors;
a memory coupled to the one or more processors which are configured to execute programmed instructions stored in the memory comprising:
obtaining project data in one or more form fields of one or more remotely located user based interfaces for a project;
validating the obtained project data from the one or more form fields of the one or more remotely located user based interfaces for the project;
recording the validated project data in a project database for the project directly from each of the one or more remotely located user based interfaces; and
generating a project tracking report based on the recorded project data.

14. The apparatus as set forth in claim 13 wherein the one or more processors is further configured to execute programmed instructions stored in the memory further comprising providing the one or more user based interfaces to one or more remotely located client computing devices.

15. The apparatus as set forth in claim 14 wherein the one or more processors is further configured to execute programmed instructions stored in the memory further comprising generating the project with a plurality of fields for tracking one or more stages in the project database, wherein the one or more form fields of the provided one or more remotely located user based interfaces corresponds with the plurality of fields.

16. The apparatus as set forth in claim 13 wherein the one or more processors is further configured to execute programmed instructions stored in the memory for the obtaining further comprising obtaining the project data in the one or more form fields of two or more of the remotely located user based interfaces for the project.

17. The apparatus as set forth in claim 13 wherein at least one of the one or more remotely located user based interfaces is an Excel based user interface and the project database is an Access database.

18. The apparatus as set forth in claim 13 wherein the one or more processors is further configured to execute programmed instructions stored in the memory for the validating further comprising formatting the obtained project data from the one or more form fields of the one or more remotely located user based interfaces for the project.
